(19) United States
(12) Patent Application Publication
(10) Pub. No.: US 2018/0141793 A1
(43) Pub. Date: May 24, 2018

(54) BOOM BUGGY

(71) Applicant: Andrew T. Altenburg, Truman, MN (US)

(72) Inventor: Andrew T. Altenburg, Truman, MN (US)

(21) Appl. No.: 15/358,968

(22) Filed: Nov. 22, 2016

(51) Int. Cl. B66F 9/06; B66F 9/22; A01K 1/015

(52) U.S. Cl. CPC B66F 9/06; B66F 2700/09; A01K 1/0151; B66F 9/22

(57) ABSTRACT

Apparatus for use to remove and/or replace cement slat, cement supports in a cement slatted flooring of an animal pen, comprising a manually operable engine driven wheeled vehicle characterized by being supportable on a slotted concrete slat flooring and on the area proximate thereto, an elevated extendible boom pivotably attached to the vehicle at the boom's proximate end and having grasping members at the boom's distal end, a hydraulic device coupled between the vehicle and the boom and between the ends of the boom for pivotally raising and lowering the boom, and manually operable controls for operating the hydraulic device located on the vehicle whereby the vehicle and the boom are manually operable to place the grasping members into the vicinity of a flooring cement slat or a flooring support for attachment thereto to raise the flooring cement slat or flooring support and carry it to an alternate site.

### FIELD OF THE INVENTION

This invention relates generally to animal pens and, more specifically to an apparatus for use in repairing and replacing the flooring of an animal pen.

### CROSS REFERENCE TO RELATED APPLICATIONS

None

### STATEMENT REGARDING FEDERALLY SPONSORED RESEARCH OR DEVELOPMENT

None

### REFERENCE TO A MICROFICHE APPENDIX

None

### BACKGROUND OF THE INVENTION

The instant invention deals with the repair and/or replacement of flooring in animal pens, such as hog pens, which are commonly used in the industry for raising, nurturing and marketing domesticated animals. Referring to FIG. 1 many pens 10 are in an enclosed barn, which has a slatted flooring comprising of slotted slabs of concrete, usually referred to as slats 11, for holding the animals over a pit, which accumulates the animals' droppings, that may be stored for further agricultural use such as for crop fertilization.

Referring to FIGS. 2 and 3 of the drawings, FIG. 2 is a partial cross-sectional side view showing some of the components that make up the animal pen flooring and FIG. 3 shows a perspective view of an individual concrete slat 11 of the animal pen slatted flooring.

The animal pen slatted flooring generally comprises a gathering pit 13 for the collection of animal wastes. Gathering pit 13 includes an encompassing sidewall 14 having a ledge 14a extending therefrom, a plurality of preferably cement posts 15 extending vertically upwards from a floor 13b of the gathering pit 13, and a plurality of cement beams 16 extending along the entire width or length of the gathering pit 13 with the plurality of cement beams 16 supported on a top end of the plurality of posts 15. The concrete slats 11 are then supported by the ledge 14a of the encompassing sidewall 14 and the plurality of cement beams 16 to enclose the entire gathering pit 13.

Each of the concrete slats 11 include a plurality of slots 12 that extends from a topside 11a to a bottom side 11b of the slat 11 with plurality of slots 12 functioning to provide an avenue for animal waste to escape from the animal supporting topside 11a to the bottom side 11b of the slat 11.

During use of the animal pen the concrete slats 11, and some of the supporting structure including cement posts 15 and cement beams 16, deteriorate over time and need to be replaced. Initial construction and installation does not present a serious problem since the enclosing barn is usually built after the pit and flooring have been completed. Since the slats and supports are heavy and somewhat cumbersome, industrial type equipment is needed in order to accomplish the process of replacing the slats within the confines of a roofed barn with some degree of efficiency and at a reasonable cost.

One system for slat replacement uses a stationary large base with an attached frame having an extended arm which is carried by the frame to reach the flooring slats which need replacement Another device utilizes a large non-movable structure with outriggers for providing stability and an upwardly extended rotatable pedestal with a pivotally mounted boom. Apparently the latter is also intended to be adaptable for remote control in lieu of manual control by an experienced operator.

### BRIEF SUMMARY OF THE INVENTION

While the prior art describes the nature of the subject matter which the invention must deal with, i.e. the structure of the animal pen, the cumbersome weight and bulk of the cement slats, the need for and difficulty of removal of deteriorated slats, etc., it does not deal with the nature of all of the somewhat complex functions necessary to complete the process of removing and replacing the bulky damaged slats.

Rather than designing and building somewhat complex large and immobile structures as in the prior art, the instant invention utilizes commercially available vehicles modified by the inventor(s) as needed to provide less costly, maneuverable, manually operable apparatus with greater flexibility undertake and complete the task of repairing the slatted animal pen flooring.

The instant invention utilizes a stripped down, at least in part, commercially available engine-driven manually operated wheeled vehicle outfitted as necessary with manually controlled hydraulically powered devices all being manually operated by a skilled experienced operator.

An elevated forward directed extendable and retractable boom with attached beam grasping members is mounted on the vehicle and the vehicle and boom are maneuvered by the operator to bring the grasping members into engagement with the beam after the slat is removed. The beam is lifted and carried to and deposited at a repair or disposal site and in a similar manner is then operated to pick up and deposit anther damaged beam or bring a replacement beam to be inserted into the pit.

Since the equipped vehicle is maneuvered and moved back and forth over at least part of the flooring from time to time, the weight of the vehicle is a factor. The forces on the vehicle attributable to lifting and transporting the beams are balanced, if needed, by weights attached to the vehicle.

A feature of the instant invention is its mobility and flexibility. The experienced operator of the vehicle, who also operates the various equipment controls, is able to adjust quite quickly as circumstances dictate. Also, the vehicle with the attached, or attachable, equipment can be readily transported as needed from one barn location to another.

### BRIEF DESCRIPTION OF THE DRAWINGS

FIG. 1 is a partial cross-sectional view of an animal pen;

FIG. 2 is a partial cross-sectional side view showing some of the components that make up the animal pen flooring of FIG. 1;

FIG. 3 shows a perspective view of an individual concrete slat for the animal pen flooring of FIG. 2;

FIG. 4 is a perspective view showing a boom buggy for use in repairing and replacing flooring comprising of slotted concrete slats over a gathering pit in an animal barn;

FIG. 5 is a close-up perspective view of a beam cradle for use with the boom buggy of FIG. 4; and

FIG. 6 is a close-up perspective view showing a slat-engaging tool operable to engage a slat.

### DESCRIPTION OF THE PREFERRED EMBODIMENT

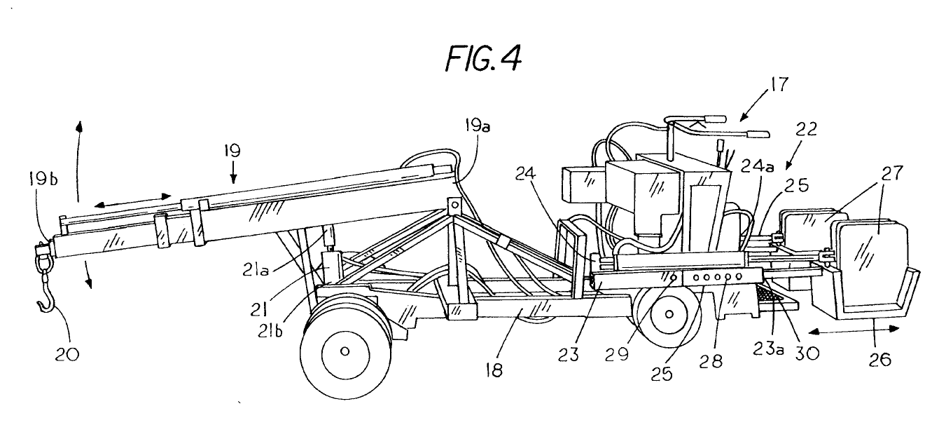

FIG. 4 is a perspective view showing an embodiment of an apparatus for use in repairing and replacing flooring comprising of slotted concrete slats over a gathering pit in an animal barn comprising a boom buggy 17.

A feature of boom buggy 17 is that boom buggy 17 is manually operable to remove the slats 11, beams 16, and/or posts 15 from the flooring and the gathering pit 13, and raise each of them to a transporting position, transport the slats 11. beams 16, and/or posts 15 to a remote site and lower and release the slats 11, beam 16, and/or post 15 at the remote site, raised a new/replacement slat, beam, or post from the remote site to a transporting position, transport new/replacement slat, beam, or post to the flooring and lower and release new/replacement slats 11, beam 16, and/or post 15 at the flooring or down into the gathering pit 13.

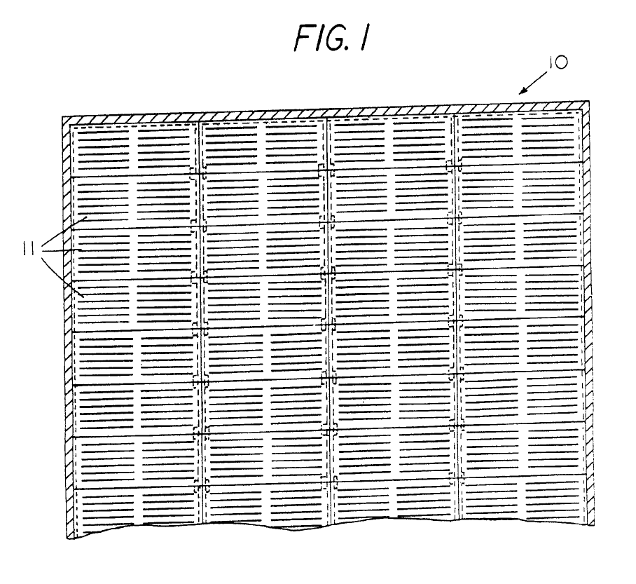

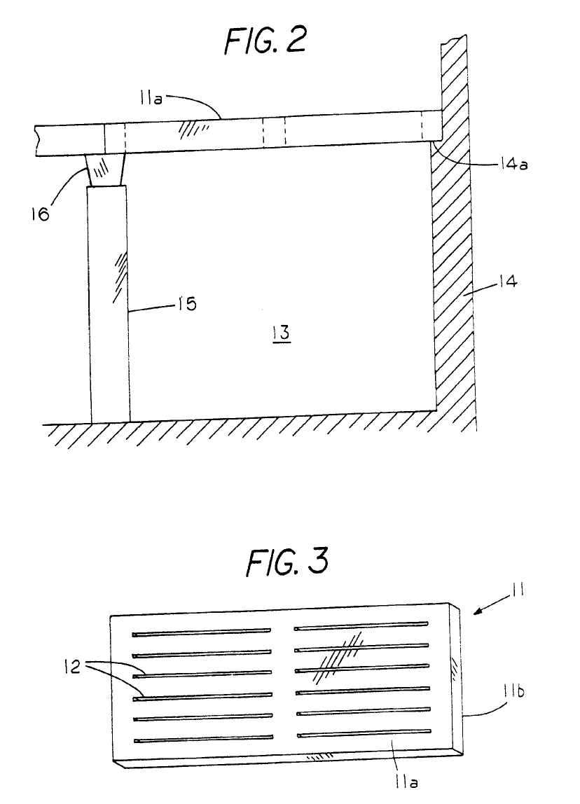

Boom buggy 17 generally comprises a manually operable engine driven wheeled vehicle 18 characterized by being supportable on a slotted concrete slat flooring and on the area proximate thereto similar to the slotted concrete slat flooring of the animal pen 10 of FIG. 1.

Boom buggy 17 includes an elevated extendible boom 19 pivotably attached to engine driven wheeled vehicle 18 at the boom 19's proximate end 19a and having a grasping member 20 at located at the boom 19's distal end 19b and a manually operated hydraulic device or hydraulic actuated member coupled between the engine driven wheeled vehicle 18 and extendible boom 19 for selectively pivotally raising and lowering extendible boom 19 to lift and deposit an engaged slats 11, beams 16, and/or posts 15.

In the embodiment of FIG. 4 the manually operated hydraulic device or hydraulic actuated member is shown as comprising a heavy duty re-enforced hydraulic cylinder 21 having a first end 21a connected to a portion of extendible boom 19 and a second end 21b connected to the engine driven wheeled vehicle 18 with hydraulic cylinder 21 manually operated to selectively pivotally raise and lower extendible boom 19 to lift and deposit the engaged concrete slats 11, beams 16, and/or posts 15.

The boom buggy 17 is also shown including a weight-adjustable bracket assembly 22 mounted to engine driven wheeled vehicle 18 with weight-adjustable bracket assembly 22 operating to counter balance a weight of the engaged slat 11, beam 16, and/or post 15 supported by engine driven wheeled vehicle 18. Weight-adjustable bracket assembly 22 generally comprises a pair of spaced apart receiving tubes 23,24 attached to opposing sides of engine driven wheeled vehicle 18 with the spaced apart receiving tubes 23,24 each having an open end 23a, 24a for receiving an end of an extendable arm 25 therein with each extendable arm 25 including a weight supporting bucket 26 attached to or proximal to the opposing ends of the extendable arms 25. Although weight-supporting buckets 26 may support a variety of different weights therein, the embodiment of FIG. 4 show weight supporting buckets 26 each support a plurality of tractor plate weights 27 therein with the amount of tractor plate weights 27 supported on supporting buckets 26 being dependent on the weight of the engaged slat 11, beam 16, and/or post 15.

In order to provide weight counter balance adjustability to weight-adjustable bracket assembly 22, the extendable arms 25 of weight-adjustable bracket assembly 22 each includes a plurality of spaced apart length adjusting orifice 28 extending therethrough along the length of the extendable arms 25 to allow the user to manually adjust the lengths of the extendable arms 25 to correspond to the weight to the engaged concrete slat 11, beam 16, and/or post 15. For example if boom buggy 17 is to engage a concrete slat 11, beam 16, and/or post 15 of a heavier weight the user would manually extend the length of extendable arms 25 to a desired corresponding length after which the user would then align the closes length adjusting orifice 28 to a locking slot 29 located on receiving tubes 23,24 and then lock the extendable arms 25 in place by extending a locking device such as but not limited to a locking pin or locking bolt through locking slot 29 and the corresponding length adjusting orifice 28.

More specifically, weight-adjustable bracket assembly 22 operates to counter balance a weight of the engaged slat 11, beam 16, and/or post 15 by two different method, namely by supporting buckets 26 supporting of different amounts of weights therein and by adjustment of the length of the extendable arms 25 of weight-adjustable bracket assembly 22.

FIG. 4 also show boom buggy 17 including a user supported weight-balancing platform 30 attached to or proximal to an end of engine driven wheeled vehicle 18 distal the grasping member 20 that is attached to extendible boom 19. User supported weight-balancing platform 30 provides an addition and/or supplemental option to counter balance a weight of the engaged slat 11, beam 16, and/or post 15.

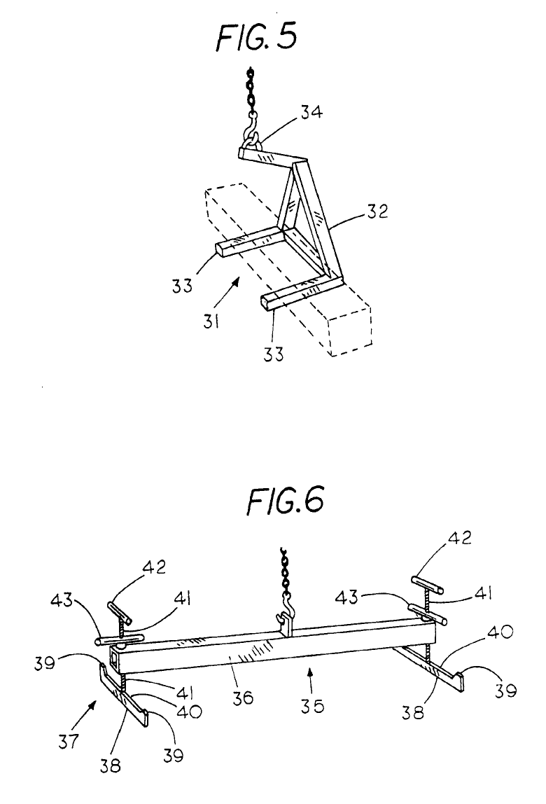

FIG. 5 is a close-up perspective view of a beam cradle 31 for use with the boom buggy 17 of FIG. 4, the beam cradle 31 operable to engage a cement support beam or a cement 16 or support post 15 in a cement slatted flooring of an animal pen to remove the beam 16, and/or post 15 from the flooring and release the beam 16 and/or post 15 at a remote site. Beam cradle 31 is shown generally comprising a triangular shaped body 32 having a pair of parallel supporting arms 33 extending preferably perpendicular from triangular shaped body 32. Beam cradle 31 also includes connection arm 34 for attachment to grasping member 20.

FIG. 6 is a close-up perspective view showing a slat-engaging tool 35 operable to engage a slat 11 to remove the slat 11 from the flooring and release the slat 11 at a remote site. Slat engaging tool 35 generally comprises an elongated main body 36 having a T-bolt slat-grasping tool 37 located proximal each of the ends of the elongated main body 36. As shown in FIG. 6, each of the T-bolt slat-grasping tool 37 includes a slat engaging base member 38 having a riser 39 located at each of the ends of the slat engaging base member 38 and a slat-engaging surface 40. Extending from slat engaging surface 40 midway between the riser 39 is a threaded shaft 41 having a threaded exterior surface and a fixed handle 42 located at an end of threaded shaft 41 distal slat-engaging surface 40. Threaded shaft 41 also includes a rotatably adjustable handle 43 supported thereon between fixed handle 42 and slat-engaging surface 40 with adjustable handle 43 functioning to assist in maintaining the engagement of slat 11 to slat-engaging surface 40 through a pressure fit or the like such as by rotationally adjusting the distance between slat-engaging surface 40 and elongated main body 36 when an engaged slat is located therebetween.

The present invention also includes a method for repairing and replacing the flooring comprising of slotted concrete slats 11 over a gathering pit 13 in an animal barn, that includes the steps of (1) providing a manually operated engine-powered wheeled vehicle 17 characterized by being supportable on the flooring and adjacent the flooring, the vehicle 17 supporting all elevated extendible boom 19 with grasping members 20 located at the distal end of the boom 19; (2) manually operating the vehicle 17 and the boom 19 to place the grasping members 20 proximate to a support 11, 15, 16 for a removed slat; (3) securing the grasping members 20 to the support 11, 15, 16; then, (4) manually operating the boom 19 and maneuvering the vehicle 17 to raise the support 11, 15, 16 and transferring it to a disposal site; then, (5) removing the grasping members 20 from the support 11, 15, 16 to release the support 11, 15, 16 at the disposal site.

The aforementioned may also include the steps of: (6) raising and lowering the boom 19 by hydraulics as needed by manually operated hydraulic controls; and (7) operating the hydraulic controls of the boom 19 by the operator of the wheeled vehicle 17.

I claim:

1. Apparatus for use to remove and/or replace cement slats, cement supports, and support posts in a cement slatted flooring of an animal pen, comprising:
a manually operable engine driven wheeled vehicle characterized by being supportable on a slotted concrete slat flooring and on the area proximate thereto;
an elevated extendible boom pivotably attached to said vehicle at said boom's proximate end and having grasping members at said boom's distal end;
a hydraulic device coupled between said vehicle and said boom and between the ends of said boom for pivotally raising and lowering said boom; and
manually operable controls for operating said hydraulic device located on said vehicle; whereby,
said vehicle and said boom are manually operable to place said grasping members into the vicinity of a flooring cement slat or a flooring support for attachment thereto to raise the flooring cement slat or flooring support and carry it to an alternate site.

2. The apparatus for use to remove and/or replace cement slats, cement supports, and support posts in a cement slatted flooring of an animal pen as described in claim 1 wherein said vehicle is manually operable to transport a flooring support raised from the flooring and lower it at a remote site.

3. The apparatus for use to remove and/or replace cement slats, cement supports, and support posts in a cement slatted flooring of an animal pen as described in claim 2 including a slat engaging tool attached to said grasping members with said slat engaging tool operable to engage a slat to remove said slat from the flooring and release said slat at a remote site.

4. The apparatus for use to remove and/or replace cement slats, cement supports, and support posts in a cement slatted flooring of an animal pen as described in claim 2 including a beam cradle attached to said grasping members with said beam cradle operable to engage a cement support beam or a support post in a cement slatted flooring of an animal pen to remove said beam or said post from the flooring and release said beam or said post at a remote site.

5. The apparatus for use to remove and/or replace cement slats, cement supports, and support posts in a cement slatted flooring of an animal pen as described in claim 2 including a weight-adjustable bracket assembly mounted to said vehicle with said weight-adjustable bracket assembly operating to counter balance a weight of said engaged slat, engaged cement support, or said engaged support post supported by said vehicle, said weight-adjustable bracket assembly comprising a pair of spaced apart tubes attached to opposing sides of said vehicle, said spaced apart tubes each having an open end for receiving a first end of an extendable arm therein with each arm including a weight supporting bucket attached to a second end of said extendable arm.

6. The apparatus for use to remove and/or replace cement slats, cement supports, and support posts in a cement slatted flooring of an animal pen as described in claim 5 including a user supported weight-balancing platform attached to an end of said vehicle distal said grasping members.

7. The apparatus for use to remove and/or replace cement slats, cement supports, and support posts in a cement slatted flooring of an animal pen as described in claim 6 including a manually operated hydraulic actuated member coupled to each of said spaced apart tube and each of said corresponding extendable arm for adjustment of a length of said extendable arm.

8. The apparatus for use to remove and/or replace cement slats, cement supports, and support posts in a cement slatted flooring of an animal pen as described in claim 5 wherein said extendable arms of said weight-adjustable bracket assembly each includes a plurality of orifices extending therethrough along a length of each of said arms for manual adjustment of a length of said arm to further counter balance a weight of said engaged slat or engaged cement support supported by said vehicle.

9. Apparatus for use to remove and/or replace cement slats, cement supports, and support posts in a cement slatted flooring of an animal pen, comprising:
a manually operable engine driven wheeled vehicle characterized by being supportable on a slotted concrete slat flooring and on the area proximate thereto;
an elevated extendible boom pivotably attached to said vehicle at said boom's proximate end and having grasping members at said boom's distal end;
a hydraulic device coupled between said vehicle and said boom and between the ends of said boom for pivotally raising and lowering said boom; and
manually operable controls for operating said hydraulic device located on said vehicle whereby said vehicle and said boom are manually operable to place said grasping members into the vicinity of a flooring cement slat or a flooring support for attachment thereto to raise the flooring cement slat or flooring support and carry it to an alternate site; and
a weight-adjustable bracket assembly mounted to said vehicle with said weight-adjustable bracket assembly operating to counter balance a weight of said engaged slat or engaged cement support supported by said vehicle.

10. The apparatus for use to remove and/or replace cement slats, cement supports, and support posts in a cement slatted flooring of an animal pen as described in claim 9 wherein said weight-adjustable bracket assembly comprises a pair of spaced apart tubes attached to opposing sides of said vehicle, said spaced apart tubes each having an open end for receiving a first end of an extendable arm therein with each arm including a weight supporting bucket attached to a second end of said extendable arm.

11. The apparatus for use to remove and/or replace cement slats, cement supports, and support posts in a cement slatted flooring of an animal pen as described in claim 10 including a manually operated hydraulic actuated member coupled to each of said spaced apart tube and each of said corresponding extendable arm for adjustment of a length of said extendable arm.

12. The apparatus for use to remove and/or replace cement slats, cement supports, and support posts in a cement slatted flooring of an animal pen as described in claim 9 including a user supported weight-balancing platform attached to an end of said vehicle distal said grasping members.

13. The apparatus for use to remove and/or replace cement slats, cement supports, and support posts in a cement slatted flooring of an animal pen as described in claim 10 wherein said extendable arms of said weight-adjustable bracket assembly each includes a plurality of orifices extending therethrough along a length of each of said arms for manual adjustment of a length of said arm to further counter balance a weight of said engaged slat or engaged cement support supported by said vehicle.

14. The apparatus for use to remove and/or replace cement slats, cement supports, and support posts in a cement slatted flooring of an animal pen as described in claim 10 wherein said weight supporting buckets of said weight-adjustable bracket assembly each support a plurality of tractor plate weighs therein.

15. The apparatus for use to remove and/or replace cement slats, cement supports, and support posts in a cement slatted flooring of an animal pen as described in claim 10 wherein said spaced apart tubes of said weight-adjustable bracket assembly are spaced apart parallel from each other.

16. The apparatus for use to remove and/or replace cement slats, cement supports, and support posts in a cement slatted flooring of an animal pen as described in claim 10 including a beam cradle attached to said grasping members with said beam cradle operable to engage a cement support beam in a cement slatted flooring of an animal pen to remove said beam from the flooring and release said beam at a remote site.

17. The apparatus for use to remove and/or replace cement slats, cement supports, and support posts in a cement slatted flooring of an animal pen as described in claim 10 including a slat engaging tool attached to said grasping members with said slat engaging tool operable to engage a slat to remove said slat from the flooring and release said slat at a remote site.

18. A method for use in repairing flooring consisting of slotted concrete slats resting on supports located within a gathering pit in an animal barn , comprising the steps of:
providing a manually operated engine-powered wheeled vehicle characterized by being supportable on the flooring and adjacent the flooring, said vehicle supporting an elevated extendible boom with grasping members located at the distal end of said boom;
manually operating said vehicle and said boom to place said grasping members proximate to a support for a removed slat;
securing said grasping members to said support; then,
manually operating said boom and maneuvering said vehicle to raise said support and transferring it to a disposal site; then,
removing said grasping members from said support to release said support at the disposal site.

19) The method as described in claim 18 wherein said boom is raised and lowered by hydraulics as needed by manually operated hydraulic controls.

20) The method as described in claim 19 wherein said hydraulic controls are operated by the operator of said wheeled vehicle.
